(19) United States
(12) Patent Application Publication
(10) Pub. No.: US 2025/0335126 A1
(43) Pub. Date: Oct. 30, 2025

(54) ELECTRONIC DEVICE AND METHOD WITH PROCESSING IN MEMORY OPERATION

(71) Applicants: Samsung Electronics Co., Ltd., Suwon-si (KR); UIF (University Industry Foundation), Yonsei University, Seoul (KR)

(72) Inventors: Bongjun KIM, Suwon-si (KR); Youngsok KIM, Seoul (KR); Sungchul LEE, Seoul (KR); Seil LEE, Seoul (KR); Suhyun LEE, Seoul (KR); Jounghoo LEE, Seoul (KR); Chaemin LIM, Seoul (KR); Hanna CHA, Seoul (KR); Jinwoo CHOI, Seoul (KR); Yeonan HA, Seoul (KR); Hanwoong JUNG, Suwon-si (KR)

(73) Assignees: Samsung Electronics Co., Ltd., Suwon-si (KR); UIF (University Industry Foundation), Yonsei University, Seoul (KR)

(21) Appl. No.: 19/060,889

(22) Filed: Feb. 24, 2025

(30) Foreign Application Priority Data
Apr. 30, 2024 (KR) 10-2024-0057770

(51) Int. Cl. G06F 3/06

(52) U.S. Cl. CPC G06F 3/0659; G06F 3/061; G06F 3/0673

(57) ABSTRACT

A method includes determining a candidate pseudo channel (PC) to which a processing in memory (PIM) instruction is assignable among a plurality of PCs based on an idle state of a PC, determining a target PC set based on the candidate PC, and allocating data and the PIM instruction to the target PC set, for the target PC set, wherein one or more target PCs included in the target PC set perform a PIM operation in parallel based on the data and the PIM instruction.

### CROSS-REFERENCE TO RELATED APPLICATIONS

This application claims the benefit under 35 USC § 119 (a) of Korean Patent Application No. 10-2024-0057770, filed on Apr. 30, 2024 in the Korean Intellectual Property Office, the entire disclosure of which is incorporated herein by reference for all purposes.

### BACKGROUND

### 1. Field

The following description relates to an electronic device and method with a processing in memory (PIM) operation.

### 2. Description of Related Art

Processing in memory (PIM) may refer to technology for performing operations or data processing within a memory. For example, PIM may accelerate various applications (e.g., deep learning) by performing memory-intensive tasks (e.g., matrix-vector multiplication (MVM)) inside a memory. As a result, PIM may reduce data movement and associated delays and may improve total processing speed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a method includes determining a candidate pseudo channel (PC) to which a processing in memory (PIM) instruction is assignable among a plurality of PCs based on an idle state of a PC, determining a target PC set based on the candidate PC, and allocating data and the PIM instruction to the target PC set, for the target PC set, wherein one or more target PCs included in the target PC set perform a PIM operation in parallel based on the data and the PIM instruction.

The method may include, when the PIM operation is not completed, determining a target PC set corresponding to a next PIM operation independent of the PIM operation and allocating data and a PIM instruction for the next PIM operation.

The allocating of the data and the PIM instruction for the next PIM operation may include determining a target PC set for the next PIM operation such that the PIM operation shares resources with the next PIM operation, and allocating the data and the PIM instruction for the next PIM operation.

The determining of the candidate PC may include determining a PC in an idle state among the plurality of PCs as the candidate PC.

The method may include updating an allocation state of the data and the PIM instruction for the one or more target PCs.

The determining of the target PC set may include determining the target PC set based on a level value input from a processor of an accelerator and predetermined tree logic.

The allocating of the data and the PIM instruction to the target PC set may include inputting the data and the PIM instruction to a port for any one target PC among the one or more target PCs, and dividing the data and the PIM instruction into numbers corresponding to the one or more target PCs and allocating the data and the PIM instruction to each of the one or more target PCs.

The inputting of the data and the PIM instruction may include inputting the data and the PIM instruction to a port of a target PC having a lowest index among the one or more target PCs.

In one or more general aspects, an accelerator includes a memory comprising a plurality of pseudo channels (PCs), and a processor configured to determine a candidate PC to which a processing in memory (PIM) instruction is assignable among the plurality of PCs based on an idle state of a PC, determine a target PC set comprising one or more of the plurality of PCs, based on the candidate PC, and allocate data and the PIM instruction to the target PC set, for the target PC set, wherein one or more target PCs included in the target PC set perform a PIM operation in parallel based on the data and the PIM instruction.

In one or more general aspects, an electronic device includes a host processor configured to provide the PIM instruction to the accelerator, and the accelerator.

In one or more general aspects, an electronic device includes a host processor configured to provide a processing in memory (PIM) instruction to an accelerator, and the accelerator configured to determine a candidate pseudo channel (PC) to which the PIM instruction is assignable among a plurality of PCs based on an idle state of a PC, determine a target PC set based on the candidate PC, allocate data and the PIM instruction to the target PC set, for the target PC set, and perform a PIM operation using the target PC set to which the data and the PIM instruction is allocated.

One or more target PCs included in the target PC set may be configured to perform the PIM operation in parallel based on the data and the PIM instruction.

The accelerator may be configured to, when the PIM operation is not completed, determine a target PC set corresponding to a next PIM operation independent of the PIM operation and allocate data and a PIM instruction for the next PIM operation.

For the allocating of the data and the PIM instruction for the next PIM operation, the accelerator may be configured to determine a target PC set for the next PIM operation such that the PIM operation shares resources with the next PIM operation, and allocate the data and the PIM instruction for the next PIM operation.

For the determining of the candidate PC, the accelerator may be configured to determine a PC in an idle state among the plurality of PCs as the candidate PC.

The accelerator may be configured to update an allocation state of the data and the PIM instruction for one or more target PCs.

For the determining of the target PC set, the accelerator may be configured to determine the target PC set based on a level value input from a processor of the accelerator and predetermined tree logic.

For the allocating of the data and the PIM instruction to the target PC set, the accelerator may be configured to receive the data and the PIM instruction as input through a port for any one target PC among one or more target PCs, and divide the data and the PIM instruction into numbers corresponding to the one or more target PCs and allocate the data and the PIM instruction to each of the one or more target PCs.

For the inputting of the data and the PIM instruction, the accelerator may be configured to input the data and the PIM instruction to a port of a target PC having a lowest index among the one or more target PCs.

The accelerator may include a processor implementing control logic, and the processor may include any one or any combination of any two or more of a field-programmable gate array (FPGA), an application-specific integrated circuit (ASIC), a central processing unit (CPU), a graphics processing unit (GPU), and a neural processing unit (NPU).

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of an accelerator.

FIG. 3 illustrates an example of an operation of a controller.

FIGS. 4 and 5 illustrate examples of an operation of an accelerator.

FIGS. 6 and 7 illustrate examples of performance of an electronic device.

FIG. 8 illustrates an example of an operation method of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms, including technical and scientific terms, used herein have the same meaning as commonly understood by one of ordinary skill in the art to which the present disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like components and a repeated description related thereto will be omitted.

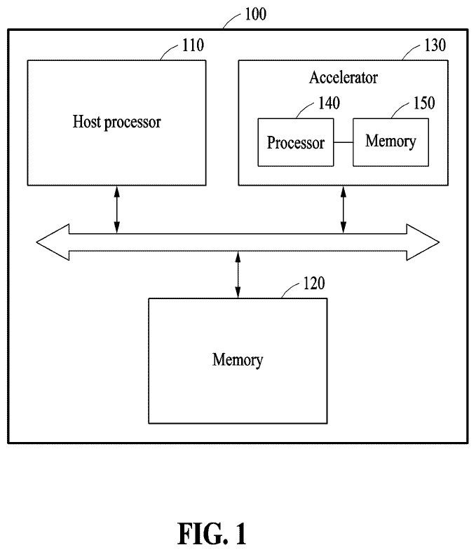

FIG. 1 illustrates an example of an electronic device.

Referring to FIG. 1, an electronic device 100 may include a host processor 110 (e.g., one or more processors), a memory 120 (e.g., one or more memories), and an accelerator 130. The host processor 110, the memory 120, and the accelerator 130 may communicate with one another through a bus, a network on a chip (NoC), or a peripheral component interconnect express (PCIe). In the example of FIG. 1, only the components related to the example described herein are illustrated as being included in the electronic device 100. Thus, the electronic device 100 may also include other general-purpose components in addition to the components illustrated in FIG. 1.

The host processor 110 may perform overall functions for controlling the electronic device 100. The host processor 110 may generally control the electronic device 100 by executing programs and/or instructions stored in the memory 120. For example, the memory 120 may include a non-transitory computer-readable storage medium storing instructions that, when executed by the processor 110, configure the processor 110 to perform any one, any combination, or all of operations and/or methods of the host processor 110 disclosed herein with reference to FIGS. 1-8. The host processor 110 may be implemented as a central processing unit (CPU), a graphics processing unit (GPU), and/or an application processor (AP), which is included in the electronic device 100, but examples are not limited thereto.

The memory 120 may be hardware for storing data having been processed or to be processed by the electronic device 100. In addition, the memory 120 may store an application, a driver, and the like to be driven by the electronic device 100. The memory 120 may include a volatile memory (e.g., dynamic random-access memory (DRAM)) and/or a non-volatile memory.

The electronic device 100 may include the accelerator 130 for an operation. The accelerator 130 may process tasks that may be more efficiently processed by a separate exclusive device (e.g., the accelerator 130) than by the general-purpose host processor 110, due to the characteristics of the tasks. Here, one or more processing elements (PEs) included in the accelerator 130 may be utilized. The accelerator 130 may include a separate exclusive processor 140. The processor 140 may be or include a field-programmable gate array (FPGA), an application-specific integrated circuit (ASIC), a CPU, a GPU, a neural processing unit (NPU), and/or a tensor processing unit (TPU). In addition, the accelerator 130 may include a separate exclusive memory 150. The memory 150 may communicate with the processor 140 and may correspond to a memory of a high bandwidth (e.g., a high bandwidth memory (HBM)) for use with the processor 140. According to an example, the memory 150 may include a plurality of pseudo channels (PCs) and may perform a processing in memory (PIM) operation using the plurality of PCs.

Hereinafter, an example of a method of performing a PIM operation using a plurality of PCs of the memory 150 by the electronic device 100 is described.

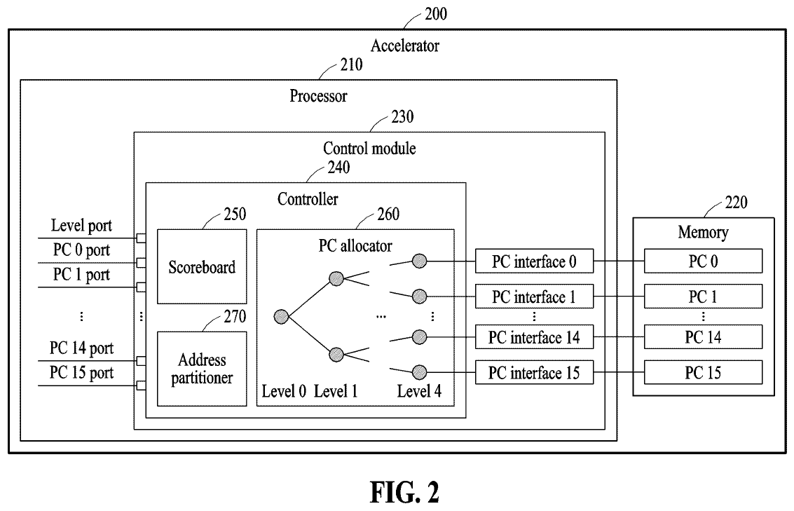

FIG. 2 illustrates an example of an accelerator.

Referring to FIG. 2, an accelerator 200 (e.g., the accelerator 130 of FIG. 1) is shown. The accelerator 200 may include a processor 210 (e.g., the processor 140 of FIG. 1) and a memory 220 (e.g., the memory 150 of FIG. 1). The description of the processor 210 and the memory 220 is the same as the description provided above with reference to FIG. 1 and is thus omitted.

The processor 210 may include control module 230. The control module 230 may be hardware including and/or implementing a control logic. The control module 230 may determine a target PC set for performing a PIM instruction. An example of a method of determining the target PC set is described later. The control module 230 may allocate input data and the PIM instruction to the target PC set. An example of a method of allocating the data and the PIM instruction to the target PC set is described later.

The memory 220 may include a plurality of PCs (e.g., PC 0 to PC 15). The plurality of PCs may be channels for performing a PIM operation. The control module 230 may allocate the data and the PIM instruction to a target PC included in the target PC set, and the target PC and may perform a PIM operation corresponding to the PIM instruction for the allocated data.

The control module 230 may include a controller 240 and a plurality of PC interfaces (e.g., PC interface 0 to PC interface 15).

The controller 240 may control the plurality of PCs of the memory 220. The controller 240 may include a scoreboard 250, a PC allocator (e.g., a PC allocator 260), and an address partitioner 270. The controller 240 may be logic hardware for determining the target PCs and transmitting the data and the PIM instruction to the target PCs.

In addition, the controller 240 may include a plurality of ports. The plurality of ports may include a level port and a plurality of PC ports (e.g., PC 0 port to PC 15 port). One PC port may be allocated to one PC. For example, the plurality of PC ports may correspond to PCs, respectively. For example, PC 0 port may correspond to PC 0, and PC 1 port may correspond to PC 1.

For example, the number of PC ports may correspond to the number of PCs. In the present disclosure, for ease of description, it is assumed that the memory 220 includes “16” PCs. However, this is only an example, and the present disclosure is not limited thereto.

The controller 240 may receive a level value as an input from the processor 210 through the level port. The controller 240 may receive the data and the PIM instruction from the processor 210 through a PC port.

The processor 210 may refer to the scoreboard 250 to determine the target PCs (e.g., the target PC set) on which the PIM operation is performed.

The scoreboard 250 may use a bit vector format. The scoreboard 250 may include information about which PCs are available. For example, the scoreboard 250 may include an idle state and a busy state for the plurality of PCs. The controller 240 may update a state of the plurality of PCs on the scoreboard 250.

The processor 210 may refer to the scoreboard 250 and may determine a PC in the idle state as a candidate PC. The controller 240 may determine the target PC from among candidate PCs. The controller 240 may determine the target PC using the PC allocator 260.

The PC allocator 260 may be logic hardware for determining the target PC. For example, the PC allocator 260 may include and/or implement tree logic in which PCs correspond to leaf nodes. However, this is only an example, and the present disclosure is not limited thereto.

The controller 240 may receive the level value from the processor 210 through the level port. The controller 240 may determine the target PC using the level value and logic. For example, the controller 240 may receive level value 1 through the level port and the logic is a binary tree logic of total 4 levels. In this example, the controller 240 may determine PCs corresponding to leaf nodes derived from any one node among nodes corresponding to level value 1 as target PCs. The controller 240 may select a node having the lowest index among nodes corresponding to the level value. For example, the controller 240 may select a first node among the nodes corresponding to level value 1 and may determine PCs 0 to 7 derived from the first node as target PCs.

The controller 240 may allocate the data and the PIM instructions for the PIM operation to one or more target PCs included in the target PC set. The controller 240 may receive the data and the PIM instruction from the processor 210 through a PC port.

The controller 240 may receive the data and the PIM instruction through any one of the PC ports corresponding to the target PCs. The controller 240 may receive the data and the PIM instruction through a PC port having the lowest index among the PC ports corresponding to the target PCs. For example, PCs 0 to 7 are determined as target PCs. In this example, the controller 240 may receive the data and the PIM instruction through a PC 0 port having the lowest index among PC ports 0 to 7 corresponding to the target PCs.

When the controller 240 receives the data and the PIM instruction, the controller 240 may allocate the data and the PIM instruction to the target PCs through the address partitioner 270.

The address partitioner 270 may be logic for distributing the data and the PIM instruction to one or more target PCs. The address partitioner 270 may prevent memory address collisions between target PCs and may distribute the data and the PIM instruction to the target PCs. The address partitioner 270 may divide the data and the PIM instruction into addresses respectively corresponding to the target PCs to prevent memory address collisions between the target PCs. The controller 240 may transmit the divided pieces of data and the divided PIM instructions to a corresponding target PC through a PC interface. Accordingly, the target PCs that have received the data and the PIM instruction may execute the PIM operation in parallel.

The PC interface may perform a PIM interface. The PIM interface may be an essential process for performing the PIM operation using the target PC. When the control module 230 is not used, the processor 210 may continue processing of the PIM interface. When the control module 230 is used, the PIM interface is performed by the PC interface and the processor 210 may perform other tasks in the meantime. For this operation, the PC interface may include a buffer (e.g., a 32 kilobytes (KB) static random-access memory (SRAM) buffer). The PIM interface may be performed for each PC. Accordingly, each PC may be connected to a corresponding dedicated PIM interface.

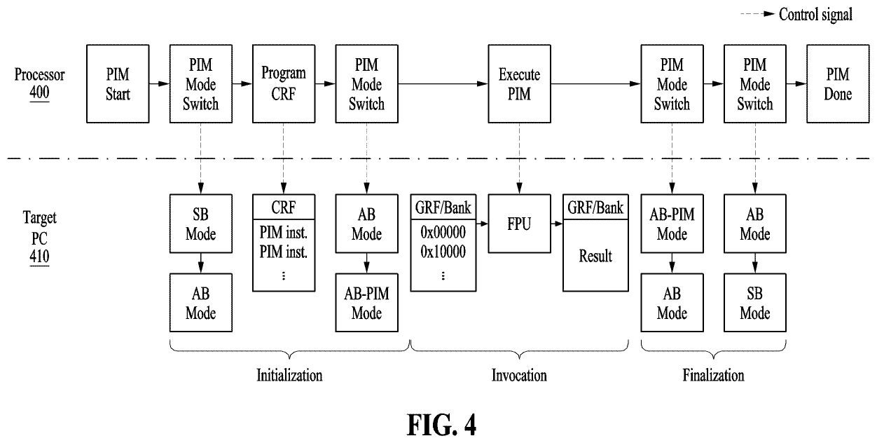

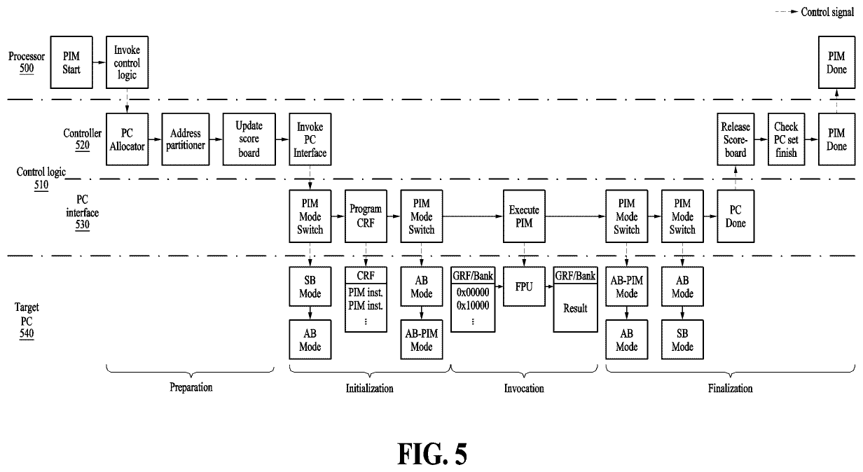

The PIM interface may be implemented with finite state machine (FSM) logic. For example, the PIM interface may include three operations of initialization, invocation, and finalization. The PC interface may allow connected target PCs to perform the PIM operation by performing the PIM interface. An example of the PIM interface is described below with reference to FIGS. 4 and 5.

One or more target PCs that receive the data and the PIM instruction through the PIM interface may perform the PIM operations in parallel.

Therefore, the processor 210 may only need to set the number of target PCs required for the PIM operation, and the controller 240 may determine the target PC and may distribute the data and the PIM instruction to allow the target PC to perform the PIM operation. For example, the processor 210 may delegate all operations related to the PIM operation to the controller 240 and may perform a separate operation (e.g., the next PIM operation).

Hereinafter, examples of an operation of the controller 240 is described through specific examples.

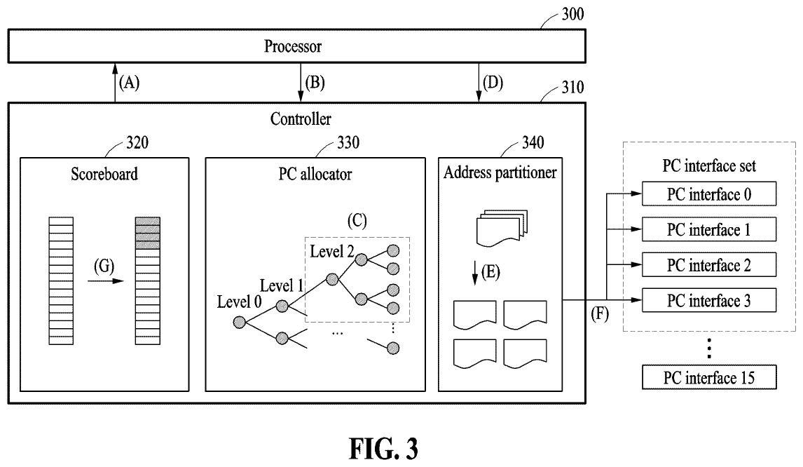

FIG. 3 illustrates an example of an operation of a controller.

In operation A, a processor 300 (e.g., the processor 140 of FIG. 1) may determine a candidate PC by referring to a scoreboard 320 of a controller 310. In FIG. 3, for ease of description, it is assumed that all PCs are in an idle state.

In operation B, the processor 300 may input a level value to the controller 310. The level value may be determined based on the number of target PCs for performing a PIM operation. For example, in binary tree logic, when the number of target PCs for performing the PIM operation is 4, the level value may be determined to be 2.

In operation C, a PC allocator 330 may determine a target PC based on the level value and logic. The PC allocator 330 may determine a PC derived from one of the nodes corresponding to the level value as the target PC. For example, when the level value is 2, the PC allocator 330 may determine a PC derived from one of the nodes corresponding to level 2 as the target PC. For example, four target PCs may be determined.

In operation D, the processor 300 may transmit data and a PIM instruction to the controller 310 through a port corresponding to the target PC. The processor 300 may transmit the data and the PIM instruction to the controller 310 through any one of ports corresponding to the target PC. The processor 300 may transmit the data and the PIM instruction to the controller 310 through a port having the lowest index among the ports corresponding to the target PC.

In operation E, the controller 310 may divide the data and the PIM instruction received through an address partitioner 340. The address partitioner 340 may divide the received data and the received PIM instruction into addresses respectively corresponding to the target PCs.

In operation F, the address partitioner 340 may allocate each of the divided pieces of data and the divided PIM instructions to a corresponding PC interface. For example, the address partitioner 340 may allocate each of the divided four pieces of data and the divided four PIM instructions to the corresponding PC interface.

In operation G, the controller 310 may update the scoreboard 320. For example, when the divided pieces of data and the divided PIM instructions are allocated to PC interfaces, the target PCs corresponding to the PC interfaces to which the divided pieces of data and the divided PIM instructions are allocated may perform the PIM operation. Accordingly, the controller 310 may update the scoreboard 320 to indicate that the target PCs are in use.

In response to the scoreboard 320 being updated, the PC interface may perform a PIM interface. An example of the PIM interface is described below with reference to FIGS. 4 and 5. FIGS. 4 and 5 illustrate examples of an operation of an accelerator.

FIG. 4 illustrates an example of execution of a PIM operation based on a processor 400 when there is no control logic being implemented.

The execution of the PIM operation may include three operations. For example, a PIM interface may include three operations of initialization, invocation, and finalization.

First, in the initialization, a processor 400 may switch a PIM mode of a target PC 410. The processor 400 may switch the PIM mode of the target PC 410 from a single bank (SB) mode to an all bank (AB) mode. The SB mode may be a mode for causing a PC to operate as a general high-bandwidth memory device. When the PIM mode changes to the AB mode, the processor 400 may upload a series of PIM instructions to command register files (CRFs). The processor 400 may switch the PIM mode of the target PC 410 from the AB mode to an AB-PIM mode. The AB mode may be a mode for offloading instructions to a PIM module of the PC. The AB-PIM mode may be a mode for causing the PIM module to execute uploaded instructions.

In the invocation, the processor 400 may control the target PC 410 to execute the PIM operation. The processor 400 may transmit a PIM invocation command to the target PC 410. The PIM invocation command may control the PIM module to perform the PIM operation on a floating point unit (FPU) or transfer data between a general register file (GRF) and a memory bank.

In the finalization, the processor 400 may switch the PIM mode of the target PC 410 from the AB-PIM mode to the SB mode. For example, the PIM operation may terminate. Subsequently, the processor 400 may read output data from the memory bank.

For ease of description, the three operations described above may be referred to as a PIM interface, which is an interface between the processor 400 and the target PC 410. For example, each of the operations performed in initialization, invocation, and finalization is only an example, and the present disclosure is not limited thereto. For example, it will be understood by one of ordinary skill in the art with an understanding of the present disclosure that other operations may be performed instead of a particular operation in each operation and other operations may be additionally performed in each operation.

Therefore, referring to FIG. 4, since the processor 400 is continuously used to perform the PIM interface, other operations (e.g., execution of a next PIM operation) may not be performed.

On the contrary, referring to FIG. 5, a PIM interface of one or more embodiments is shown when there is control logic 510 between a processor 500 and a target PC 540.

Referring to FIG. 5, the processor 500 may use the control logic 510 when executing the PIM operation. Accordingly, the processor 500 may no longer participate in the PIM interface after being used to control (e.g., activate) the control logic 510 when executing the PIM operation.

For example, when the processor 500 determines candidate target PCs, transmits a level value to the control logic 510, and transmits data and a PIM instruction to the control logic 510, the processor 500 may no longer participate in the PIM interface.

Referring to FIG. 5, in response to the control logic 510 being activated, a preparation operation may be performed through a controller 520. The preparation may include determining a target PC set, dividing data and a PIM instruction, and updating a scoreboard.

The controller 520 may activate a PC interface 530 in response to the preparation. For example, the controller 520 may provide data and a PIM instruction to the PC interface 530.

The PC interface 530 may perform the PIM interface with the target PC 540. Since the description of the PIM interface is provided above with reference to FIG. 4, description thereof is omitted.

In conclusion, when using the control logic 510, the processor 500 may not be involved in the PIM interface. For example, the processor 500 may perform other operations (e.g., execution of a next PIM operation). As a result, even when a first PIM operation is not completed (e.g., during the first PIM operation), a second PIM operation independent of the first PIM operation may be executed, thereby improving an operation speed of an electronic device and/or accelerator of one or more embodiments compared to a typical electronic device and/or accelerator not using such control logic. In addition, the first PIM operation and the second PIM operation may be performed independently on a target PC set determined for each of the PIM operations.

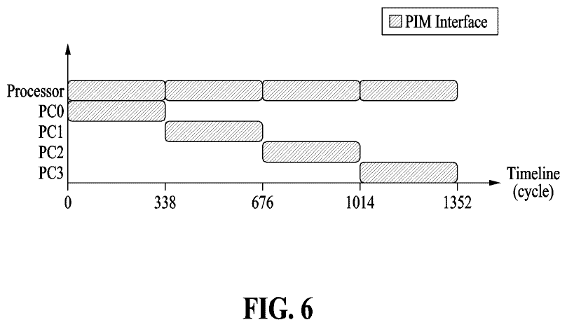

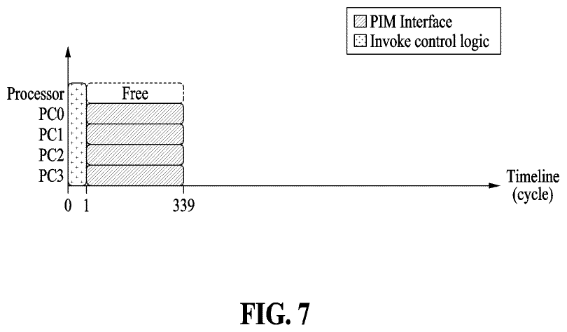

FIGS. 6 and 7 illustrate examples of performance of an electronic device.

Referring to FIG. 6, a graph showing a case of the typical electronic device and/or accelerator operating a PIM operation using four target PCs without using control logic is illustrated. FIG. 6 may be a graph showing a case in which division of data and a PIM instruction is not performed since the control logic is not used.

As a result, an operation on any one target PC may need be completed to perform an operation on a next target PC. Therefore, even though the PIM operation is allocated to four target PCs (e.g., PC 0 to PC 3), the operation may be performed on each target PC in series. For example, in response to the PIM operation on PC 0 terminating, the PIM operation on PC 1 may be performed, and in response to the PIM operation on PC 1 terminating, the PIM operation on PC 2 may be performed.

In addition, since the control logic is not utilized, a processor may need to continue to engage with a PIM interface. As a result, the processor may not perform other operations (e.g., execution of a next PIM operation).

On the contrary, referring to FIG. 7, a graph showing a case of the electronic device and/or accelerator of one or more embodiments performing a PIM operation using control logic and four target PCs (e.g., PC 0 to PC 3). Referring to FIG. 7, since the control logic is used, data and a PIM instruction may be divided into addresses respectively corresponding to target PCs and the divided pieces of data and the divided PIM instructions may be transmitted to the corresponding target PCs. As a result, the PIM operation on PC 0 to PC 3 may be performed in parallel, thereby improving the operation speed of the electronic device and/or accelerator of one or more embodiments compared to the typical electronic device and/or accelerator not using such control logic.

In addition, since the control logic is used, a processor may be only used to execute the control logic and may not be involved in a PIM interface. As a result, the processor may perform other operations (e.g., execution of a next PIM operation).

According to an example, even when a first PIM operation is not completed (e.g., during the first PIM operation), the processor of one or more embodiments may execute a second PIM operation independent of the first PIM operation. The first PIM operation may be performed on a target PC set corresponding to the first PIM operation. The second PIM operation may be performed by a target PC set corresponding to the second PIM operation being allocated and receiving the data and the PIM instruction for the second PIM operation. For example, even when the first PIM operation is not completed (e.g., during the first PIM operation) on PC 0 to PC 3, the electronic device and/or accelerator of one or more embodiments may perform the second PIM operation on PC 4 to PC 7. Here, the first PIM operation and the second PIM operation may share resources. The target PC set of the second PIM operation may be determined not to overlap with the target PC set of the first PIM operation such that the first PIM operation and the second PIM operation may share operational resources.

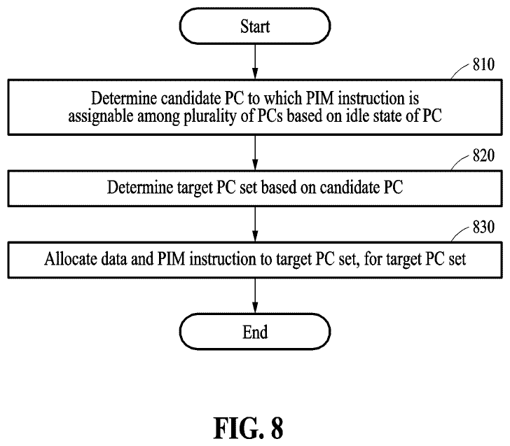

FIG. 8 illustrates an example of an operation method of an electronic device.

In the following examples, operations may be performed sequentially but not necessarily. For example, the order of the operations may change and at least two of the operations may be performed in parallel. Operations 810 and 830 may be performed by any one or any combination of components of an electronic device (e.g., the electronic device 100 of FIG. 1).

In operation 810, the electronic device may determine a candidate PC to which a PIM instruction is assignable among a plurality of PCs based on an idle state of a PC.

In operation 820, the electronic device may determine a target PC set based on the candidate PC.

In operation 830, the electronic device may allocate data and a PIM instruction to the target PC set.

The descriptions provided with reference to FIGS. 1 to 7 may apply to the operations shown in FIG. 8, and thus further detailed descriptions are omitted.

The electronic devices, host processors, memories, accelerators, processors, control modules, control logics, controllers, scoreboards, PC allocators, address partitioners, target PCs, PC interfaces, electronic device 100, host processor 110, memory 120, accelerator 130, processor 140, memory 150, accelerator 200, processor 210, memory 220, control module 230, controller 240, scoreboard 250, PC allocator 260, address partitioner 270, processor 300, controller 310, scoreboard 320, PC allocator 330, address partitioner 340, processor 400, target PC 410, processor 500, control logic 510, controller 520, PC interface 530, and target PC 540 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method comprising:
determining a candidate pseudo channel (PC) to which a processing in memory (PIM) instruction is assignable among a plurality of PCs based on an idle state of a PC;
determining a target PC set based on the candidate PC; and
allocating data and the PIM instruction to the target PC set, for the target PC set,
wherein one or more target PCs included in the target PC set perform a PIM operation in parallel based on the data and the PIM instruction.

2. The method of claim 1, further comprising, when the PIM operation is not completed, determining a target PC set corresponding to a next PIM operation independent of the PIM operation and allocating data and a PIM instruction for the next PIM operation.

3. The method of claim 2, wherein the allocating of the data and the PIM instruction for the next PIM operation comprises:
determining a target PC set for the next PIM operation such that the PIM operation shares resources with the next PIM operation; and
allocating the data and the PIM instruction for the next PIM operation.

4. The method of claim 1, wherein the determining of the candidate PC comprises determining a PC in an idle state among the plurality of PCs as the candidate PC.

5. The method of claim 1, further comprising updating an allocation state of the data and the PIM instruction for the one or more target PCs.

6. The method of claim 1, wherein the determining of the target PC set comprises determining the target PC set based on a level value input from a processor of an accelerator and predetermined tree logic.

7. The method of claim 1, wherein the allocating of the data and the PIM instruction to the target PC set comprises:
inputting the data and the PIM instruction to a port for any one target PC among the one or more target PCs; and
dividing the data and the PIM instruction into numbers corresponding to the one or more target PCs and allocating the data and the PIM instruction to each of the one or more target PCs.

8. The method of claim 7, wherein the inputting of the data and the PIM instruction comprises inputting the data and the PIM instruction to a port of a target PC having a lowest index among the one or more target PCs.

9. An accelerator comprising:
a memory comprising a plurality of pseudo channels (PCs); and
a processor configured to:
determine a candidate PC to which a processing in memory (PIM) instruction is assignable among the plurality of PCs based on an idle state of a PC;
determine a target PC set comprising one or more of the plurality of PCs, based on the candidate PC; and
allocate data and the PIM instruction to the target PC set, for the target PC set,
wherein one or more target PCs included in the target PC set perform a PIM operation in parallel based on the data and the PIM instruction.

10. An electronic device comprising:
a host processor configured to provide the PIM instruction to the accelerator of claim 9; and
the accelerator of claim 9.

11. An electronic device comprising:
a host processor configured to provide a processing in memory (PIM) instruction to an accelerator; and
the accelerator configured to:
determine a candidate pseudo channel (PC) to which the PIM instruction is assignable among a plurality of PCs based on an idle state of a PC;
determine a target PC set based on the candidate PC;
allocate data and the PIM instruction to the target PC set, for the target PC set; and
perform a PIM operation using the target PC set to which the data and the PIM instruction is allocated.

12. The electronic device of claim 11, wherein one or more target PCs included in the target PC set are configured to perform the PIM operation in parallel based on the data and the PIM instruction.

13. The electronic device of claim 11, wherein the accelerator is configured to, when the PIM operation is not completed, determine a target PC set corresponding to a next PIM operation independent of the PIM operation and allocate data and a PIM instruction for the next PIM operation.

14. The electronic device of claim 13, wherein, for the allocating of the data and the PIM instruction for the next PIM operation, the accelerator is configured to:
determine a target PC set for the next PIM operation such that the PIM operation shares resources with the next PIM operation; and
allocate the data and the PIM instruction for the next PIM operation.

15. The electronic device of claim 11, wherein, for the determining of the candidate PC, the accelerator is configured to determine a PC in an idle state among the plurality of PCs as the candidate PC.

16. The electronic device of claim 11, wherein the accelerator is configured to update an allocation state of the data and the PIM instruction for one or more target PCs.

17. The electronic device of claim 11, wherein, for the determining of the target PC set, the accelerator is configured to determine the target PC set based on a level value input from a processor of the accelerator and predetermined tree logic.

18. The electronic device of claim 11, wherein, for the allocating of the data and the PIM instruction to the target PC set, the accelerator is configured to:
receive the data and the PIM instruction as input through a port for any one target PC among one or more target PCs; and
divide the data and the PIM instruction into numbers corresponding to the one or more target PCs and allocate the data and the PIM instruction to each of the one or more target PCs.

19. The electronic device of claim 18, wherein, for the inputting of the data and the PIM instruction, the accelerator is configured to input the data and the PIM instruction to a port of a target PC having a lowest index among the one or more target PCs.

20. The electronic device of claim 11, wherein
the accelerator comprises a processor implementing control logic, and
the processor comprises any one or any combination of any two or more of a field-programmable gate array (FPGA), an application-specific integrated circuit (ASIC), a central processing unit (CPU), a graphics processing unit (GPU), and a neural processing unit (NPU).
